(19) United States
(12) Patent Application Publication
(10) Pub. No.: US 2008/0014873 A1
(43) Pub. Date: Jan. 17, 2008

(54) METHODS AND APPARATUS FOR ADAPTIVE LOCAL OSCILLATOR NULLING

(76) Inventors: Yvonne L. Krayer, Oakton, VA (US); Todd A. Upchurch, Lovettsville, VA (US); William D. Barnhart, Oakton, VA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 11/457,003

(22) Filed: Jul. 12, 2006

(51) Int. Cl. H04B 1/04; H01Q 11/12

(52) U.S. Cl. 455/114.2; 455/118

(57) ABSTRACT

Methods and apparatus to adaptively null leakage from a local oscillator.

### BACKGROUND

As is known in the art, local oscillator (LO) leakage can result in less than optimal performance of quadrature modulator circuits. In conventional designs, one can only optimize the performance at one set of environmental and frequency conditions, and accept the performance degradation at other conditions, which in many applications is quite considerable.

Use of a conventional quadrature modulator single conversion transmit scheme typically results in significant LO leakage at or near the transmit frequency. While LO leakage can be reduced by balancing the DC offset at the quadrature modulator inputs (nulling), the offset is highly sensitive to small variations in voltage and frequency as well as temperature.

Previous attempts to cancel LO leakage by combining—180 degree phase shifted LO signals at the mixer output have proven sensitive to frequency and temperature variations. This sensitivity can render such arrangements unusable in certain applications.

Many known transmitter applications employ a quadrature modulator to perform upconversion of in-phase (I) and quadrature (Q) baseband signals. In a typical transmitter application, the local oscillator (LO) leakage is filtered out after the final conversion. However, when using a quadrature modulator in a direct conversion transmitter, leakage of the LO cannot be filtered out since it falls in the transmit band. LO leakage is due to DC offsets at the modulator inputs mixing with the LO, which produces a spectral tone at the LO frequency.

### BRIEF DESCRIPTION OF THE DRAWINGS

The foregoing features of this invention, as well as the invention itself, may be more fully understood from the following description of the drawings in which:

FIG. 1 is a functional block diagram of a system having adaptive LO nulling in accordance with exemplary embodiments of the invention;

FIG. 2 is a schematic depiction of an exemplary power detection circuit that can form a part of the system of FIG. 1;

FIG. 3 is a schematic depiction of an exemplary quadrature modulation configuration that can form a part of the system of FIG. 1;

FIG. 4 is a flow diagram showing an exemplary sequence of steps to achieve adaptive nulling in accordance with exemplary embodiments of the invention.

### DETAILED DESCRIPTION

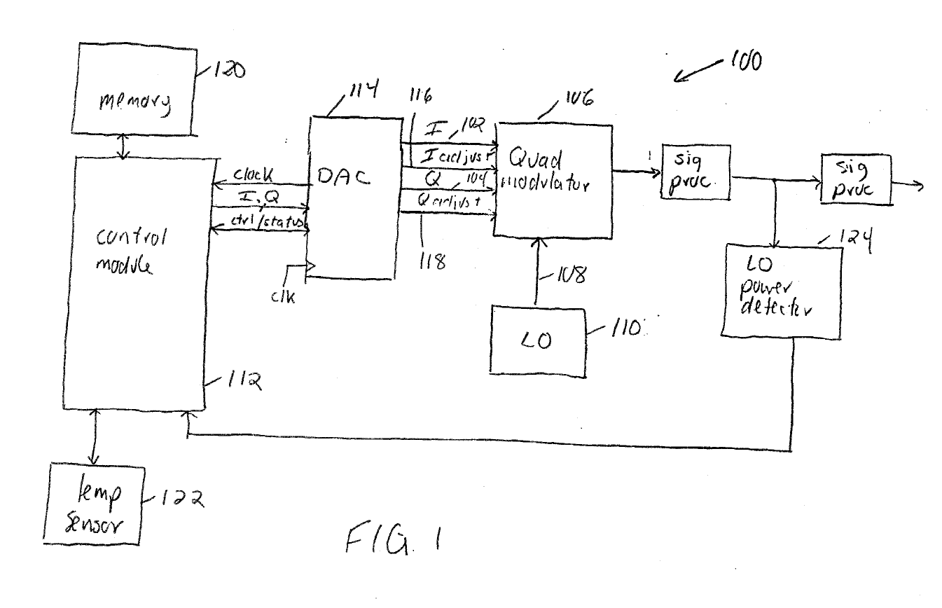

FIG. 1 shows an exemplary system 100 having adaptive local oscillator (LO) nulling in accordance with exemplary embodiments of the invention. In one embodiment, data is generated in digital form that is ultimately transmitted as radio signal energy, such as radio frequency (RF) energy. In-phase and Quadrature (I and Q) data 102, 104 is provided to a frequency mixer, shown as a quadrature modulator 106, that receives a LO signal 108 from a LO 110. In the illustrated embodiment, digital I and Q data is sent from a control module 112 to a digital-to-analog converter (DAC) 114, which sends analog information to the quadrature modulator 106. An I adjust signal 116 and a Q adjust signal 118 are provided to adjust the respective I and Q signals to the quadrature modulator 106. The I and Q adjust signals 116, 118 from the DAC 114 provide optimal nulling of the LO leakage, as described more fully below.

Memory 120 stores calibration information to be used by the control module 112, which can be provided in a Field Programmable Gate Array (FPGA) circuit. A temperature sensor 122 provides temperature information to the control module 118 as part of the nulling process, as described more fully below. A power detector circuit 124 measures LO leakage and provides this information to the control module 112. In an exemplary embodiment, a digital-to-analog converter (DAC) 116 coupled to the control module 112 provides the I and Q adjust signals 106, 108 to the quadrature modulator.

In an exemplary embodiment, the control module 112 provides information to the DAC 116 for generating the initial I and Q adjust signals 116, 118 based upon temperature and frequency. During operation, the leakage detector 124 provides LO leakage information to the control module 112. The control module 112 then controls the DAC 114 for providing optimal I and Q adjust signals 116, 118 to minimize the LO leakage.

In one embodiment, testing of the system 100 is conducted to characterize quadrature modulator 106 input offset levels required to null the local oscillator (LO) 110 over a range of temperatures and frequencies. The collected data is used to populate a lookup table, which can be stored in the memory 120, containing offset values versus temperature and frequency. During initialization, the host programs the LO synthesizer to the desired frequency and queries the temperature sensor 122 to obtain a temperature reading. The host then reads the offset values from the lookup table entry corresponding to the temperature sensor reading and the known LO frequency.

It is understood that the range and/or granularity of temperature and frequency can vary to meet the needs of a particular application. For example, some applications may require as much precision as possible over a relatively narrow temperature range. Another application can require relatively wide ranges of temperature and frequency with less granularity.

In an exemplary embodiment, the LO leakage is measured by zeroing the inputs to the quadrature modulator 106 and switching its output into a high-sensitivity log power detector in the power detector module 124. Note that after zeroing the quadrature modulator inputs, the LO leakage is essentially the only RF signal present at the input to the log power detector.

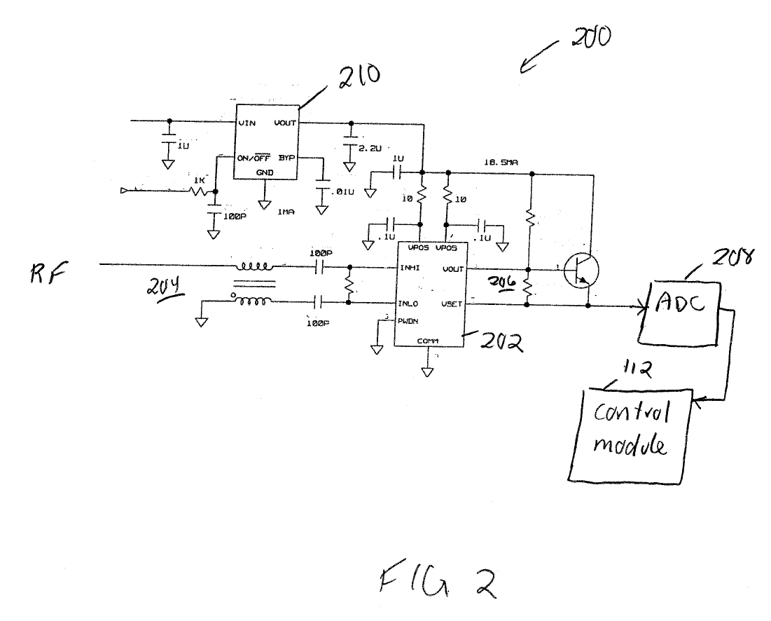

FIG. 2 shows an exemplary power detector circuit 200, which can correspond to the LO power detector module 124 of FIG. 1. The power detector 200 includes a logarithmic power detector 202 to convert the RF power at the input 204 to a log-scaled DC voltage at an output 206. The output voltage is linearly proportional to the decibel value of the measured RF power from the quad modulator. The voltage output of the log power detector 202 is sampled by an analog-to-digital converter (ADC) 208 and made available to the control module 112. In one particular embodiment, the power detector 202 includes part number AD8313 logarithmic detector/controller by Analog Devices of Norwood, Mass. The circuit 200 can further include a regulator 210 coupled to the power detector 202.

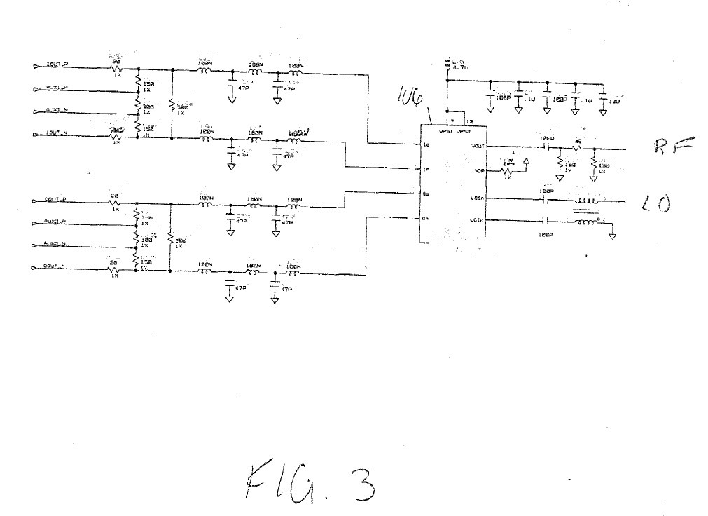

FIG. 3 shows further details of the signals provided to the quadrature modulator 106 by the current output DAC 114 (see FIG. 1). The system uses the DAC to generate the input signals to the quadrature modulator 106. The input offset levels at the quadrature modulator inputs can be adjusted by sourcing or sinking a small amount of additional DC current on one side of each differential input. More particularly, signals IOUT_P, IOUT_N and QOUT_P, QOUT_N are the differential I and Q signal inputs to the quadrature modulator. Signals AUX1_P, AUX1_N and AUX2_P, AUX2_N are the differential offset adjustment inputs from the DAC to source or sink DC current for optimal LO nulling.

Due to the quadrature modulator 106 sensitivity to minor changes in temperature and frequency, a simple lookup table cannot provide optimal LO nulling across a realistic set of environmental and operational conditions. To overcome this limitation, the input offset levels are adaptively set to obtain optimal nulling of the LO leakage for any arbitrary operating and environmental conditions.

In an exemplary embodiment, initialization of the lookup table, which can be stored in memory 120 (FIG. 1), will set the offset values near the optimal values; these initial values are used as a starting point for further nulling. The initial offset adjust values provide a ‘coarse’ level of nulling and real-time LO leakage measurements to adapt the offset values provide a ‘fine’ level of nulling.

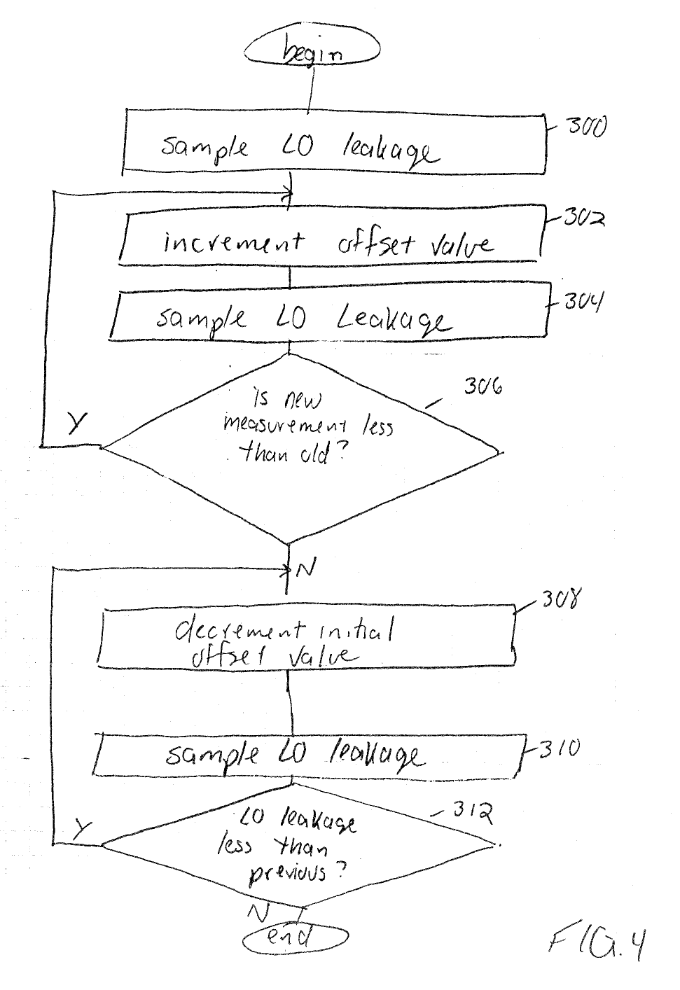

FIG. 4 shows an exemplary sequence of steps to achieve adaptive nulling in accordance with exemplary embodiments of the invention. In step 300, the process begins by sampling the LO leakage to obtain a baseline measurement. In step 302, one of the offset values is incremented by a relatively small amount and the LO leakage is sampled again. It is determined in step 304 whether the new measurement is less than the baseline measurement. If so, in step 306 the increment/sample process is repeated. If the new measurement is greater than the baseline, then the initial offset value is decremented in step 308. In step 310, the LO leakage is sampled and in step 312 it is determined whether the LO leakage is less than the previous value. If so, processing continues in step 308. If not, processing terminates.

This process continues until a local minimum is found. Once a local minimum is found for the I offset value, the process is repeated to locate a local minimum for the Q offset value. Since changing the offset at one of the quadrature modulator inputs slightly affects the bias characteristics of the other input, the process of finding a local minimum for the I offset value is repeated after finding the optimal Q offset value.

In addition to magnitude, the input offset adjustment depends on the polarity (source vs. sink) of the I and Q adjustment signals and the side of the differential input to which it is applied. Under certain conditions, it is possible that the optimal offset is of a different polarity or input side than the nearest lookup table value. In one embodiment, the system detects an occurrence of this discontinuity and performs the iterative search again after changing the polarity and/or input side of each channel as appropriate.

If a user-defined LO leakage threshold has not been met after completing the iterative search, the system performs a coarse scan of offset values across possible combinations of polarity and input side for each channel. The coarse settings that produce the minimum LO leakage are recorded and used as a starting point for a final iterative search.

Based on simulation results, the coarse scan method for given parameters requires approximately 200 ms to locate the optimal settings for minimum LO leakage. By using a lookup table to provide a starting point for the iterative search instead of scanning all possible settings, the time required for the algorithm to locate the optimal settings has been reduced by a factor of 10, to approximately 20 ms.

While exemplary embodiments having illustrated architectures have been shown and described herein, it is understood that various modifications and substitutions can be made without departing from the invention. Alternative components, as well and different partitioning between hardware and software will be apparent to one of ordinary skill in the art. For example, while an illustrative embodiment includes an FPGA component, it will be readily apparent to one of ordinary skill in the art that alternative embodiments can include processors, discrete components and other devices well known to one of ordinary skill in the art.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method, comprising:
(a) setting first and second offset adjust signals to initial levels based upon temperature and frequency information for minimizing local oscillator (LO) leakage output from a frequency mixer receiving inphase (I) and quadrature (Q) signals;
(b) measuring LO leakage during operation of the frequency mixer; and
(c) adjusting the first and second offset adjust signals to minimize the LO leakage output.

2. The method according to claim 1, wherein the frequency mixer includes a quadrature modulator.

3. The method according to claim 1, further including storing an initial value for the first and second offset adjust signals for each temperature and frequency in a range of temperatures and a range of frequencies.

4. The method according to claim 3, further including, when detecting a temperature change greater than a predetermined amount, setting the first and second offset values to the initial value for the detected temperature.

5. The method according to claim 4, further including repeating steps (b) and (c).

6. The method according to claim 1, further including identifying a local minima for the first offset adjust signal.

7. The method according to claim 6, further including identifying a local minima for the second offset adjust signal and repeating identifying the local minima for the first offset adjust signal.

8. The method according to claim 1, further including receiving a LO leakage threshold.

9. A system, comprising:
a frequency mixer to generate a radio frequency (RF) output;
a digital-to-analog converter (DAC) coupled to the mixer to provide analog inphase (I) and quadrature (Q) and inphase and quadrature offset adjust signals; and
a control module coupled to the DAC to provide digital inphase and quadrature signals;
a temperature sensor coupled to the control module, wherein the control module sets the inphase and quadrature offset adjust signals to initial levels based upon temperature and frequency information for minimizing local oscillator (LO) leakage output from the frequency mixer; and
a power detection circuit to measure the LO leakage during operation of the frequency mixer to enable adjustment of the inphase and quadrature offset adjust signals to minimize the LO leakage output.

10. The system according to claim 9, wherein the frequency mixer includes a quadrature modulator.

11. The system according to claim 9, further including a memory to store an initial value for the first and second offset adjust signals for each temperature and frequency in a range of temperatures and a range of frequencies.

12. The system according to claim 11, wherein the control module, when detecting a temperature change greater than a predetermined amount, sets the first and second offset values to the initial value for the detected temperature.

13. The system according to claim 9, wherein the DAC is a current controlled.

14. The system according to claim 9, wherein the control module includes a field programmable gate array.

15. A system, comprising:
a transmitter including
a frequency mixer to generate a radio frequency (RF) output;
a digital-to-analog converter (DAC) coupled to the mixer to provide analog inphase (I) and quadrature (Q) and inphase and quadrature offset adjust signals; and
a control module coupled to the DAC to provide digital inphase and quadrature signals;
a temperature sensor coupled to the control module, wherein the control module sets the inphase and quadrature offset adjust signals to initial levels based upon temperature and frequency information for minimizing local oscillator (LO) leakage output from the frequency mixer; and
a power detection circuit to measure the LO leakage during operation of the frequency mixer to enable adjustment of the inphase and quadrature offset adjust signals to minimize the LO leakage output.

16. The system according to claim 15, wherein the frequency mixer includes a quadrature modulator.

17. The system according to claim 15, further including a memory to store an initial value for the first and second offset adjust signals for each temperature and frequency in a range of temperatures and a range of frequencies.

18. The system according to claim 17, wherein the control module, when detecting a temperature change greater than a predetermined amount, sets the first and second offset values to the initial value for the detected temperature.

19. The system according to claim 18, wherein the control module effects measuring LO leakage during operation of the frequency mixer to adjust the first and second offset adjust signals for minimizing the LO leakage output.
